(19) United States
(12) Patent Application Publication
(10) Pub. No.: US 2012/0323712 A1
(43) Pub. Date: Dec. 20, 2012

(54) TRANSACTION PRODUCT WITH PUMP ASSEMBLY

(75) Inventors: Brian R. HOLT, Minneapolis, MN (US); Jesse GADOLA, Minneapolis, MN (US); Rafael SORIANO, Eagan, MN (US); Donald C. CLARK, Seattle, WA (US)

(73) Assignee: TARGET BRANDS, INC., MINNEAPOLIS, MN (US)

(21) Appl. No.: 13/180,098

(22) Filed: Jul. 11, 2011

Related U.S. Application Data
(60) Provisional application No. 61/498,433, filed on Jun. 17, 2011.

(51) Int. Cl. G06K 19/077; F16K 37/00; G06K 19/04; G06Q 30/00; G06K 19/00; G06K 19/06

(52) U.S. Cl. 705/17; 235/487; 235/492; 235/493; 235/494; 137/551

(57) ABSTRACT

A transaction product includes a substantially rigid housing, a pump assembly, and an account identifier. The substantially rigid housing defines a substantially liquid-tight reservoir, an outflow aperture, and an external surface. The substantially liquid-tight reservoir is configured to maintain a liquid therein. The pump assembly is enclosed within the substantially rigid housing and is in communication with the substantially liquid-tight reservoir and the outflow aperture. The pump assembly is configured to move liquid from the substantially liquid-tight reservoir, through the pump assembly, and out the outflow aperture and into an external environment surrounding the substantially rigid housing. The account identifier is statically connected to the external surface of the substantially rigid housing and links the substantially rigid housing to at least one of an account and a record and is machine readable by a point-of-sale terminal.

### CROSS-REFERENCE TO RELATED APPLICATIONS

This non-provisional application claims the benefit under 35 U.S.C. §119(e) to U.S. Provisional Patent Application No. 61/498,433, filed Jun. 17, 2011, which is incorporated by reference herein in its entirety.

### BACKGROUND OF THE INVENTION

Stored-value cards and other transaction products come in many forms. A gift card, for example, is a type of transaction product that includes a pre-loaded or selectively loaded monetary value. In one example, a consumer buys a gift card having a specified value for presentation as a gift to another person. In another example, a consumer is offered a gift card as an incentive to make a purchase. A gift card, like other transaction cards, can be “recharged” or “reloaded” at the direction of the bearer. The balance associated with the gift card declines as the gift card is used, encouraging repeat visits to the retailer or other provider issuing the gift card. Additionally, the gift card generally remains in the user's purse or wallet, serving as an advertisement or reminder to revisit the associated retailer. Gift cards and other transaction cards provide a number of advantages to both the consumer and the retailer.

### SUMMARY OF THE INVENTION

One aspect of the present invention relates to a transaction product including a substantially rigid housing, a pump assembly, and an account identifier. The substantially rigid housing defines a substantially liquid-tight reservoir, an outflow aperture, and an external surface. The substantially liquid-tight reservoir is configured to maintain a liquid therein. The pump assembly is enclosed within the substantially rigid housing and is in communication with the substantially liquid-tight reservoir and the outflow aperture. The pump assembly is configured to move liquid from the substantially liquid-tight reservoir, through the pump assembly, and out the outflow aperture and into an external environment surrounding the substantially rigid housing. The account identifier is statically connected to the external surface of the substantially rigid housing and links the substantially rigid housing to at least one of an account and a record and is machine readable by a point-of-sale terminal. Stored-value cards, methods of providing a transaction card, and other embodiments of stored-value or transaction cards and associated combinations are also disclosed.

### BRIEF DESCRIPTION OF THE DRAWINGS

Embodiments of the invention will be described with respect to the figures, in which like reference numerals denote like elements, and in which:

FIG. 1 is a front, perspective view illustration of a transaction product, according to one embodiment of the present invention.

FIG. 2 is a front view illustration of a transaction product of FIG. 1, according to one embodiment of the present invention.

FIG. 3 is a rear view illustration of the transaction product of FIG. 1, according to one embodiment of the present invention.

FIG. 4 is a right side view illustration of the transaction product of FIG. 1, according to one embodiment of the present invention.

FIG. 5 is a left side view illustration of the transaction product of FIG. 1, according to one embodiment of the present invention.

FIG. 6 is a top view illustration of the transaction product of FIG. 1, according to one embodiment of the present invention.

FIG. 7 is a bottom view illustration of the transaction product of FIG. 1, according to one embodiment of the present invention.

FIG. 8 is an exploded, perspective view illustration of the transaction product of FIG. 1, according to one embodiment of the present invention.

FIG. 9 is a rear, perspective view illustration of the transaction product of FIG. 1 with a rear housing member of the transaction product removed, according to one embodiment of the present invention.

FIG. 10 is a front view illustration of a transaction product assembly including the transaction product of FIG. 1, according to one embodiment of the present invention.

FIG. 11 is a front view illustration of a backer of the transaction product assembly of FIG. 10, according to one embodiment of the present invention.

FIG. 12 is a rear view illustration of a backer of the transaction product assembly of FIG. 10, according to one embodiment of the present invention.

FIG. 13 is a flow chart illustrating a method of assembling a transaction product assembly, according to one embodiment of the present invention.

FIG. 14 is a flow chart illustrating a method of encouraging purchase and facilitating use of a transaction product assembly, according to one embodiment of the present invention.

FIG. 15 is a flow chart illustrating a method of using a transaction product assembly, according to one embodiment of the present invention.

### DETAILED DESCRIPTION

The following detailed description of the invention provides examples and is not intended to limit the invention or the application and uses of the invention. Furthermore, there is no intention to be bound by any theory presented in the preceding background of the invention or the following detailed description of the invention.

A stored-value card or other transaction product is adapted to facilitate making purchases of goods and/or services at, for example, a retail store or web site. According to one embodiment, an original consumer buys a transaction product to give a recipient who in turn is able to use it to pay for goods and/or services. A transaction product, according to embodiments of the present invention, provides the consumer and recipient with extra amusement and functionality in addition to the ability to pay for goods and/or services with the associated transaction product.

In particular, according to one embodiment, the transaction product includes a reservoir for water, a pump in communication with the reservoir, and an output nozzle in communication with the pump. A bearer of the transaction product fills the reservoir with water and actuates the pump causing the transaction product to squirt water from the reservoir out of the nozzle of the transaction product via the reservoir. In one embodiment, this amusing aspect of the transaction product is displayed and promoted on the packaging used for the transaction product in a manner promoting the sale, use, and/or loading of the transaction product by potential consumers and/or bearers of the transaction product.

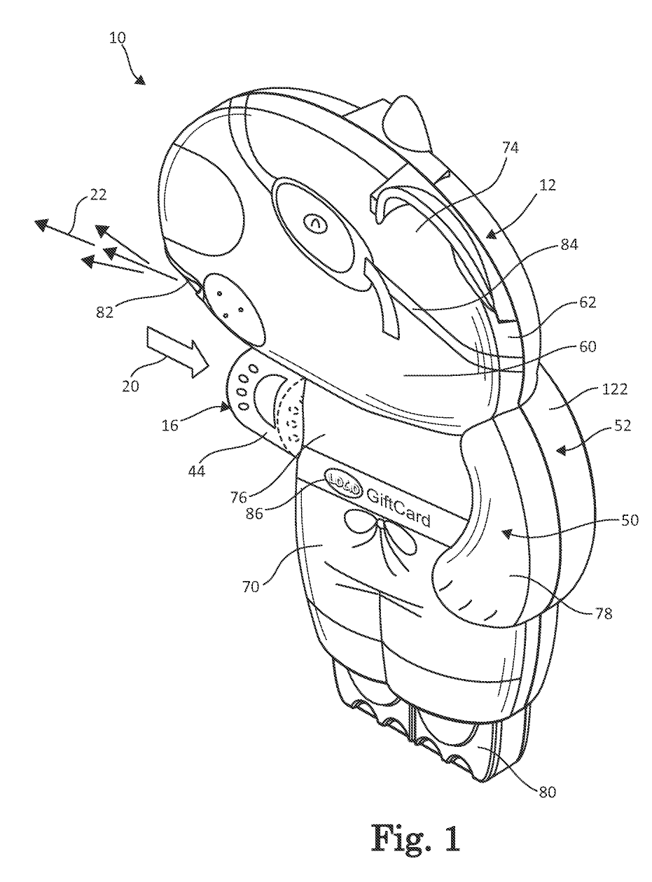

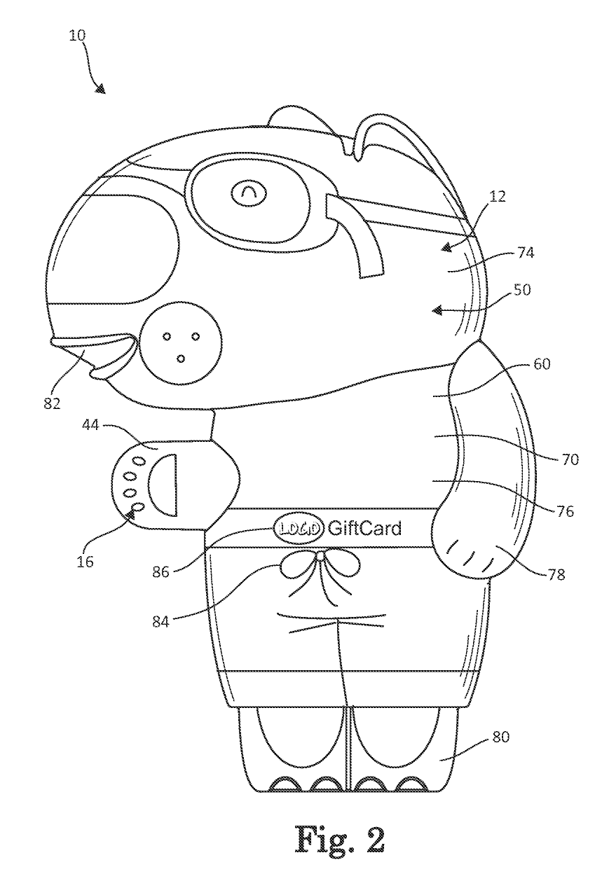

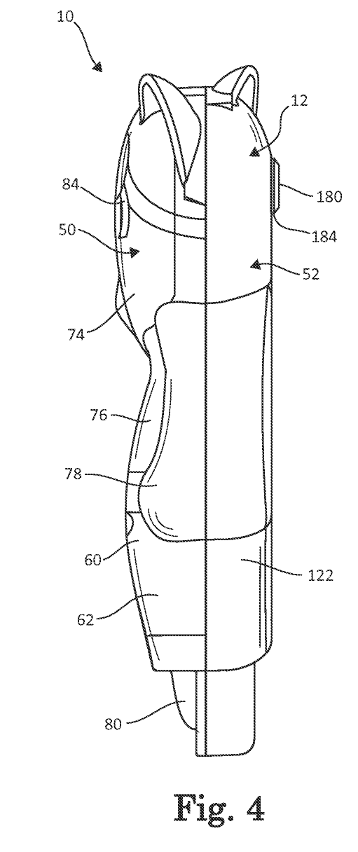

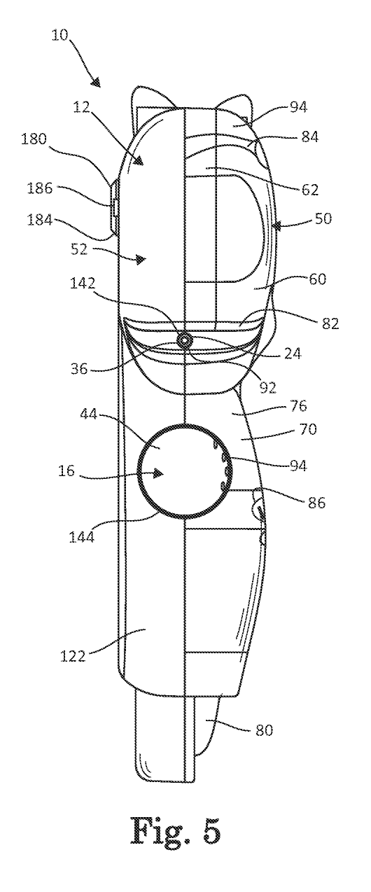

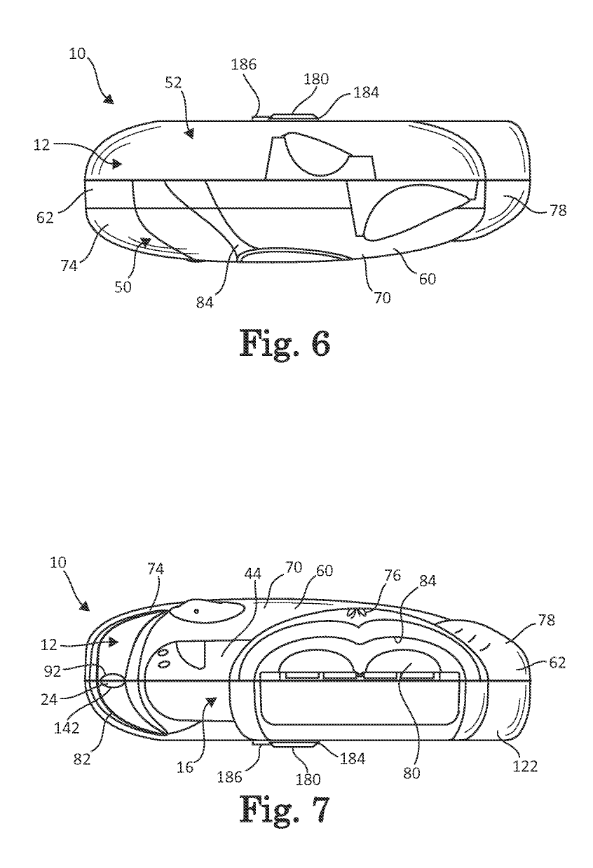

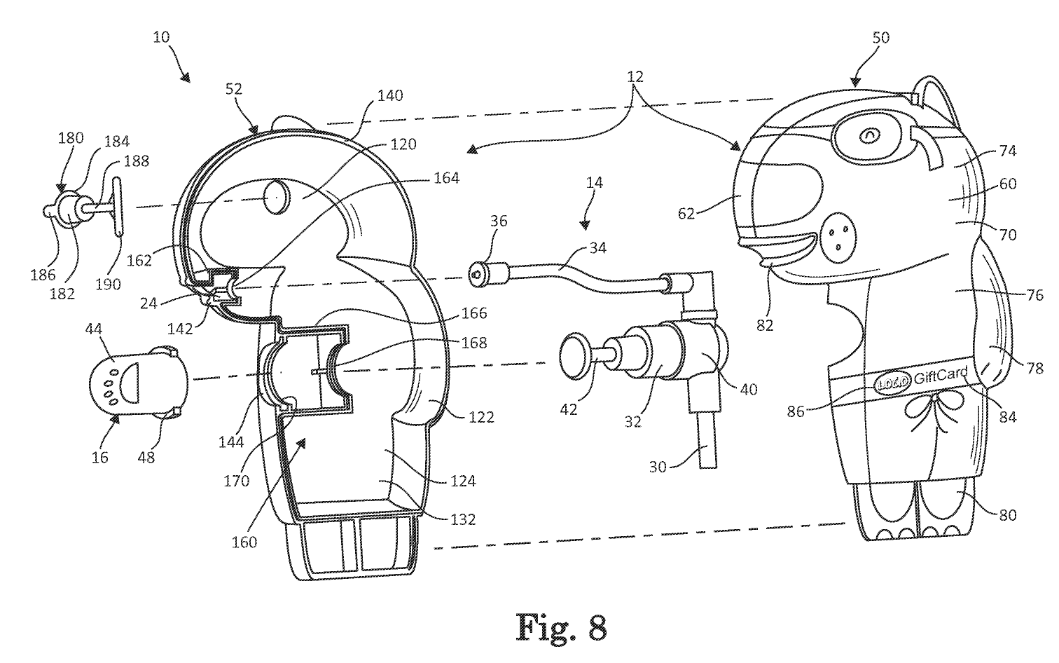

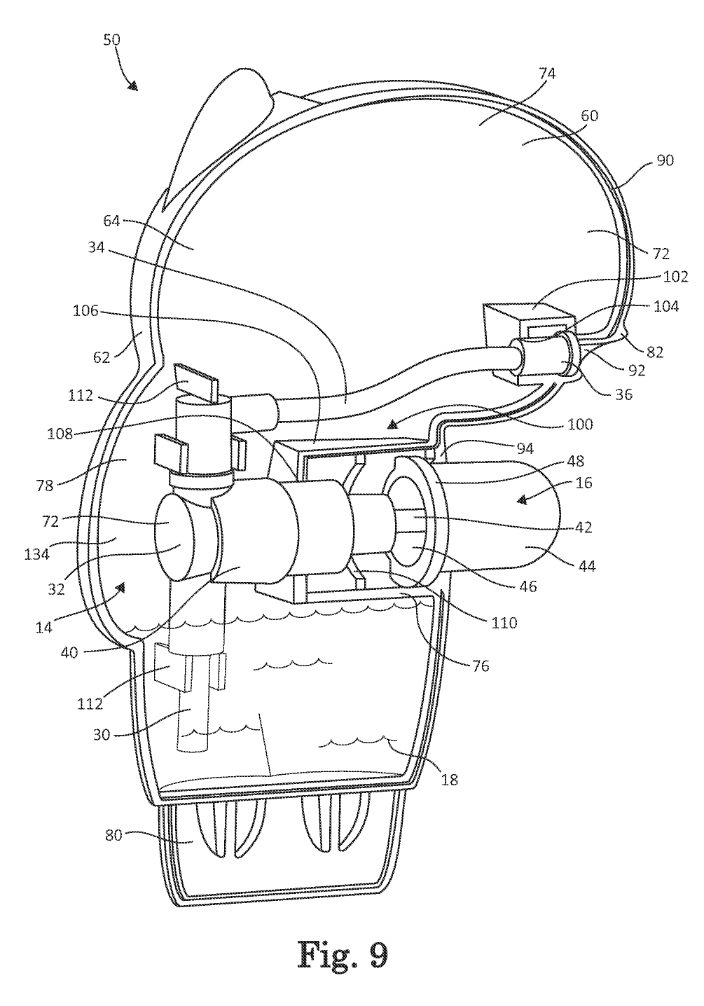

Turning to the figures, FIGS. 1-8 illustrate various views of one embodiment of a transaction product 10 such as a stored-value product (e.g., a gift card, phone card, etc.), credit product, etc. according to the present invention. Transaction product 10 is configured to be used toward the purchase and/or use of goods and/or services and includes an enclosure or housing 12, a pump assembly 14 (or other water movement assembly), and a trigger 16. Housing 12 is configured to maintain water 18 (FIG. 9) or other suitable fluid (e.g., liquid) therein such that when a bearer of transaction product 10 interacts with trigger 16 (e.g., by pressing, switching, or imparting other suitable movement of trigger 16), as generally indicated by arrow 20 in FIG. 1, pump assembly 14 is actuated to pump water 18 from within housing 12 out of transaction product 10 out of an aperture 24 (FIGS. 5 and 8) in housing 12 as generally indicated in by arrows 22 in FIG. 1.

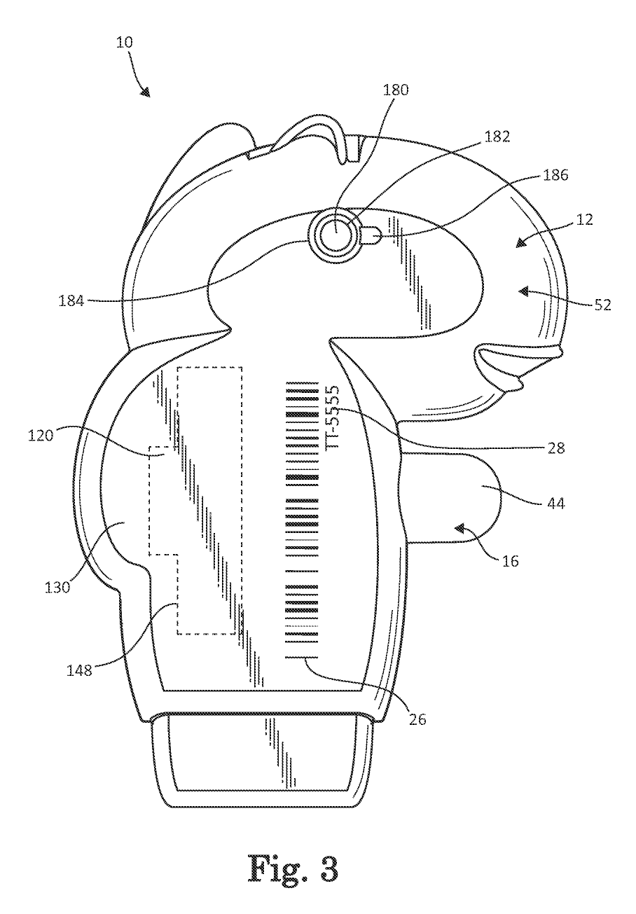

Transaction product 10 further includes an account identifier 26 (FIG. 3) such as a bar code, magnetic strip, a smart chip or other electronic device, a radio frequency identification (RFID) device or other suitable identifier readily machine readable by a point-of-sale terminal or other account access station or kiosk. Account identifier 26 indicates an account or record to which transaction product 10 is linked. The account or record of the monetary or other balance on transaction product 10 optionally is maintained on a database, other electronic or manual record-keeping system or, in the case of “smart” cards for example, on a chip or other electronics or devices on transaction product 10 itself. Accordingly, by scanning account identifier 26, the account or record linked to transaction product 10 is identified and can subsequently be activated, have amounts debited therefrom and/or have amounts added thereto.

In one embodiment, account identifier 26 is printed on an outside surface of housing 12 and includes a character string or code 28 (e.g., a number and or letter string) configured to provide additional security to the use of transaction product 10 and/or configured to be read by a bearer of transaction product 10 to facilitate use of transaction product 10 for web site or other purchases outside of a brick-and-mortar type retail establishment. With the above in mind, account identifier 26 is one example of means for linking transaction product 10 with an account or record, and account identifier 26 is one example of means for activating or loading value on transaction product 10.

Pump assembly 14 is a mechanism providing squirt gun functionality to transaction product 10. In one embodiment, pump assembly 14 includes an intake tube 30, a pump 32, an outflow tube 34, and a nozzle 36. One end of intake tube 30 is open and in communication with a reservoir 54 in housing 12, and a second, opposing end of intake tube 30 is placed in communication with pump 32. In one example, a one-way valve (not shown) is positioned between pump 32 and intake tube 30 or otherwise positioned on the side of pump 32 nearest intake tube 30 to allow fluid, e.g., water 18, to enter pump 32 but substantially prohibits or at least impedes fluid from exiting pump 32 via intake tube 30.

Pump 32 includes a housing or cylinder 40 and a piston 42 spring loaded and biased to extend farther away from cylinder 40. In one example, a spring (not shown), which biases piston 42, also interacts with a wall of cylinder 40 opposite piston 42. When piston 42 is moved, e.g., upon initiation by a bearer (not shown) of transaction product 10 as indicated by arrow 20 in FIG. 1, piston 42 is downstroked moving into cylinder 40, depressing the spring, decreasing an internal volume of cylinder 40, and moving water 18 or air out of cylinder 40. When bearer removes force to piston 42, the spring forces piston 42 to undergo an upstroke, moving piston 42 out of cylinder 40, expanding the internal volume of cylinder 40, and sucking water 18 or air from reservoir 54 into pump 32. As described above, pump assembly 14 or pump 32 alone are examples of means for moving and expelling water from reservoir 54.

Water 18 is forced out of pump 32 via outflow tube 34 through another one-way valve (not shown) which allows fluid to exit through outflow tube 34, but does not allow fluid to flow back to pump 32 via outflow tube 34. Outflow tube 34 extends from pump 32, in one example, opposite intake tube 30, to nozzle 36. Nozzle 36 includes a tapered pass through or other construction to speed up and/or direct flow of water 18 out of nozzle 36.

In one example, trigger 16 is positioned to interact with piston 42 such that user interaction with trigger 16, which is extends outside housing 12, causes piston 42 to move in response to movement of trigger 16. Trigger 16 and/or piston 42 are examples of means for actuating pump assembly 14 to move and expel water from reservoir 54 out housing 12. In one embodiment, trigger 16 includes a casing 44 in the form of a domed, hollow shell forming a cavity 46 therein. In one embodiment, casing 44 is formed to appear as a portion, e.g., an appendage such as an arm, of a character or object where housing 12 appears as another portion of the character or object. For example, where housing 12 appears as a dog, trigger 16 may appear as an appendage, such as a leg of the dog. A flange 48 extends substantially or at least partially circumferentially around a perimeter of casing 44 near an open end of casing 44. Flange 48 is configured to interact with housing 12 to control movement of trigger 16 and to substantially prevent trigger 16 from inadvertently being removed from its place relative to and partially within housing 12. Trigger 16 receives an extension of piston 42 within cavity 46 such that movement of trigger 16 generally causes corresponding movement of piston 44.

In one embodiment, housing 12 includes a first or front housing member 50 and a second or rear housing member 52 coupled to one another to define an internal chamber or reservoir 54 therebetween. Reservoir 54 is configured to selectively maintain water 18 in a substantially watertight fashion generally only allowing water to leave reservoir 54 upon user interaction with pump 32. As such, housing 12 is one example of means for holding water.

In one embodiment, as described with reference to FIGS. 1, 2 and 9, front housing member 50 generally includes a front portion 60 and sidewall portion 62. Front portion 60 defines a majority of front housing member 50 and defines forwardly facing, outside surface 70 (e.g., FIG. 3) and a rearwardly facing, inside surface 72 (FIG. 9) opposite outside surface 70. An open chamber 64 is defined within front housing member 50 between inside surface 72 of front portion 60 and sidewall portion 62.

In one embodiment, outside surface 70 of front portion 60 is curved or otherwise three-dimensionally formed to provide a relief in the shape of a character, item, or other subject, for example, a shape of a dog as illustrated in the figures. In one example, front housing member 50 defines a head 74, a body 76, one or more arms/feet 78 and 80, and/or a mouth 82 of a character. As such, this portion of housing 12 is one example of means for defining a character including means for providing areas of relief to outside surface 70. While various arrangements of head 74, body 76, one or more arms/feet 78 and 80, and/or mouth 82 are contemplated. In one example, at least head 74 and body 76 are formed relative to one another in an inverted “L” shape effectively forming a handle portion (e.g., body 76) and barrel portion (e.g., head 74) of transaction product 10 in a form that can be fairly easily grasped by the bearer (not shown) of transaction product 10 and used as a squirt gun. In one example, the handle portion or body 76 extends substantially perpendicularly relative to the barrel portion or head 74. In one embodiment, front housing member 50 and/or trigger 16 includes decorative indicia 84 further defining the character, etc. on front portion 60 thereof.

Front housing member 50 and/or other parts of housing 12 may additionally or alternatively include brand indicia 86, which identify a brand associated with transaction product 10 such as identifying a product brand, a store brand, department, etc. Other combinations or selections of indicia to be included on housing 12 are also contemplated. In one embodiment, indicia 84, 86, etc. are one of printed to and/or printed to a label or sticker applied to one or both of front housing member 50 and/or rear housing member 52.

Sidewall portion 62 extends from front portion 60 away from outside surface 70 and substantially about the entire perimeter of front portion 60. In one embodiment, sidewall portion 62 extends with a substantially perpendicular orientation relative to front portion 60. Sidewall portion 62 extends from front portion 60 to define an inside edge 90 opposite front portion 60. In one example, inside edge 90 is formed as a stepped edge.

In one embodiment, a nozzle cutout 92 extends from inside edge 90 toward front portion 60 to partially form aperture 24. Nozzle cutout 92 is sized and shaped to receive a part, e.g., about half, of a cross-sectional shape of nozzle 36. A trigger cutout 94 also extends from inside edge 90 toward front portion 60 and is configured to receive a part, e.g., about half, of a cross-sectional shape of trigger 16 as will be further described below.

In one example, front housing member 50 includes a plurality of registration features 100 extending away from, e.g., rearwardly from, inside surface 72 and being configured to facilitate assembly of transaction product 10. In one embodiment, the plurality of registration features 100 includes nozzle housing walls 102 forming a structure configured to aid in properly positioning nozzle 36. In one example, nozzle housing walls 102 substantially surround nozzle 36 in combination with a similar structure of rear housing member 52 (as will be further described below) to form a barrier for water 18 of other fluid contained in reservoir 54 substantially preventing or at least decreasing leakage of fluid form reservoir 54 around nozzle 36. In one embodiment, an internal nozzle cutout 104 is formed in nozzle housing walls 102 and is configured to register the position of nozzle 36 relative to front housing member 50.

In one example, the plurality of registration features 100 of front housing member 50 includes trigger housing walls 106 forming a structure configured to aid in properly positioning trigger 16. In one example, trigger housing walls 106 substantially surround trigger 16 in combination with a similar structure of rear housing member 52 (as will be further described below) to form a barrier for water 18 or other fluid contained in reservoir 54 substantially preventing or at least decreasing any leakage of fluid from reservoir 54 around trigger 16. In one embodiment, an internal trigger cutout 108 is formed in trigger housing walls 106 and is configured to register the position of casing 44 of trigger 16 relative to front housing member 50.

In one embodiment, a trigger stop 110 is defined within a chamber defined by internal, trigger housing walls 106. Trigger stop 110 extends radially inwardly from each side of trigger housing walls 106 and is configured to limit movement of trigger 16 into housing 12 by interaction with flange 48 of trigger 16. Similar stops near the outermost portion of trigger housing walls 106 may also be used to interact with flange 48 or other portion of trigger 16 to substantially prevent inadvertent removal of trigger 16 from housing 12.

Additional registration features 100 such as pump assembly protrusions or registration walls 112 are included in one embodiment. Pump assembly registration walls 112 are positioned to extend from inside surface 72 and form walls for registering and maintaining pump assembly 14 in a desired position relative to front housing member 50 as will be apparent to those of skill in the art.

In one embodiment, as described with primary reference to FIGS. 1, 3, and 8, rear housing member 52 generally includes a rear portion 120 and a sidewall portion 122. Rear portion 120 defines a majority of rear housing member 52 and defines rearwardly facing, outside surface 130 (e.g., FIG. 3) and a forwardly facing, inside surface 132 (FIG. 8) opposite outside surface 130. In one embodiment, outside surface 130 of rear portion 120 is substantially planar. An open chamber 124 is defined within rear housing member 52 between inside surface 132 of rear portion 120 and sidewall portion 122.

In one embodiment, sidewall portion 122 is sized and shaped to fit directly adjacent sidewall portion 62 of front housing member 50. In one embodiment, rear housing member is provided with an inverted “L” shape effectively forming a handle portion and a barrel portion of transaction product 10 in a form that can be fairly easily grasped by the bearer of transaction product 10 and used as a squirt gun, for example, with the handle portion extending substantially perpendicularly relative to the barrel portion.

Sidewall portion 122 extends from rear portion 120 away from outside surface 130 and substantially about the entire perimeter of sidewall portion 122. In one embodiment, sidewall portion 122 extends with a substantially perpendicular orientation relative to rear portion 120. Sidewall portion 122 extends from rear portion 120 to define an inside edge 140 opposite rear portion 120. In one example, inside edge 140 is formed as a stepped edge.

In one embodiment, a nozzle cutout 142 extends from inside edge 140 toward rear portion 120 to partially form aperture 24. Nozzle cutout 142 is sized and shaped to receive a part, e.g., about half, of a cross-sectional shape of nozzle 36. A trigger cutout 144 also extends from inside edge 140 toward rear portion 120 and is configured to receive a part, e.g., about half, of a cross-sectional shape of trigger 16 as will be further described below.

Housing 12, more particularly, in one example, rear housing member 52, defines a filling hole 146 for use in filling reservoir 54 with water or other suitable liquid. In one embodiment, filling hole 146 is formed through rear portion 120 of second housing member 52, however, various other positions for filling hole 146 are also contemplated and will be apparent to those of skill in the art upon reading this application. Filling hole 146 is one example of means for filling and refilling housing 12, more particularly, reservoir 54 in housing 12.

In one embodiment, rear portion 120 of rear housing member 52 includes redemption indicia, which are generally indicated by a dashed box 148 in FIG. 3. In one example, redemption indicia 148 are alternatively or additionally included on other suitable portions of housing 12. Redemption indicia 148 indicate that transaction product 10 is redeemable for the purchase of goods and/or services and that, upon use, a value of the purchased goods and/or services will be deducted from the financial account or record linked to transaction product 10. In one embodiment, redemption indicia 148 include phrases such as “<NAME OF STORE> GiftCard” and “This GiftCard is redeemable for merchandise or services at any of our stores or at our web site,” and/or provides help or phone line information in case of a lost, stolen or damaged stored-value card, etc. Other indicia, such as decorative indicia 84 and/or brand indicia 86 may also be included on second housing member 52.

In one example, rear housing member 52 includes a plurality of registration features 160 extending away from (e.g., rearwardly from) inside surface 132 and configured to facilitate assembly of transaction product 10. In one embodiment, the plurality of registration features 160 includes nozzle housing walls 162 forming a structure configured to aid in properly positioning nozzle 36. In one example, nozzle housing walls 162 substantially surround nozzle 36 in combination with nozzle housing walls 102 of front housing member 50 and, where nozzle housing walls 102 and 162 are glued, ultrasonically welded, or otherwise coupled to one another forming a barrier for water 18 of other fluid contained in reservoir 54 substantially preventing or at least decreasing leakage of such fluid from reservoir 54 around nozzle 36. In one embodiment, an internal nozzle cutout 164 is formed in nozzle housing walls 162 and is configured to register the position of nozzle 36 relative to rear housing member 52.

In one example, the plurality of registration features 160 of rear housing member 52 includes trigger housing walls 166, which form a structure configured to aid in properly positioning trigger 16. In one example, trigger housing walls 166 substantially surround trigger 16 in combination with trigger housing walls 106 of front housing member 50 and, where trigger housing walls 106 and 166 are glued, ultrasonically welded, or otherwise coupled to one another forming a barrier for water 18 or other fluid contained in reservoir 54 substantially preventing or at least decreasing leakage of such fluid from reservoir 54 around trigger 16. In one embodiment, an internal trigger cutout 168 is formed in trigger housing walls 166 and is configured to register the position of piston 42 and, therefore, of casing 44 of trigger 16 that surrounds piston 42 relative to rear housing member 52.

In one embodiment, a trigger stop 170 is defined within a chamber defined by internal, trigger housing walls 166. Trigger stop 170 extends radially inwardly from each side of trigger housing walls 166 and is configured to limit movement of trigger 16 into housing 12 by interaction with flange 48 of trigger 16. Similar stops near the outermost portion of trigger housing walls 166 may also be used to interact with flange 48 or other portion of trigger 16 to substantially prevent inadvertent removal of trigger 16 from housing 12.

In one embodiment, each of front housing member 50 and rear housing member 52 is substantially rigid and/or formed by injection molding of plastic (e.g., polycarbonate, polystyrene, polyvinyl chloride (PVC), acrylonitrile butadiene styrene (ABS), polyethylene terephthalate (PET), teslin, polyactide (PLA) and acrylic) or other suitable material to define the various attributes of front housing member 50 and rear housing member 52. Other methods of forming front housing member 50 and rear housing member 52 are also contemplated.

Transaction product 10 additionally includes a plug 180. Plug 180 is sized and shaped to tightly fit within filling hole 146 of housing 12 to selectively cover filling hole 146 and to substantially prevent water 18 or other fluids from inadvertently escaping reservoir 54. In one embodiment, plug 180 includes a cork 182, a perimeter flange 184, a tab 186, a tether 188, and/or a cross bar 190. Cork 182 is sized to fit within filling hole 146 by frictionally interacting with edges of filling hole 146 into housing 12 to plug filling hole 146. In one embodiment, cork 182 is substantially cylindrical with a tapered diameter such that the further cork 182 is moved through filing hole 146 the tighter seal is formed between cork 182 and edges of filling hole 146. Perimeter flange 184 extends around an end of cork 182 having the largest diameter. Perimeter flange 184 has an outside diameter greater than a diameter of filling hole 146 such that perimeter flange 184 substantially prevents cork 182 from being pushed all the way through filling hole 146 and into reservoir 54.

In one embodiment, a tab 186 extends radially outwardly from perimeter flange 184 and is configured to be relatively easily grasped by a bearer to pull cork 182 out of filling hole 146. In one example, tether 188 extends from cork 182 opposite perimeter flange 184 (e.g., from an end of cork 182 having its smallest diameter) with a thin, elongated shape and terminates at an end having a crossbar 190 extending substantially perpendicular to tether 188. Crossbar 190 has a length longer than a diameter of filling hole 146 such that when crossbar 190 is positioned in reservoir 54 and cork 182 is removed from filling hole 146, crossbar 190 interacts with rear portion 120 around filling hole 146 to substantially prevent plug 180 from inadvertently being entirely separated from housing 12, thereby, decreasing the likelihood of accidental separation of plug 180 from housing 12 and/or loss of plug 180. In one embodiment, plug 180 is formed of a single piece of injection molded plastic or otherwise suitably formed material.

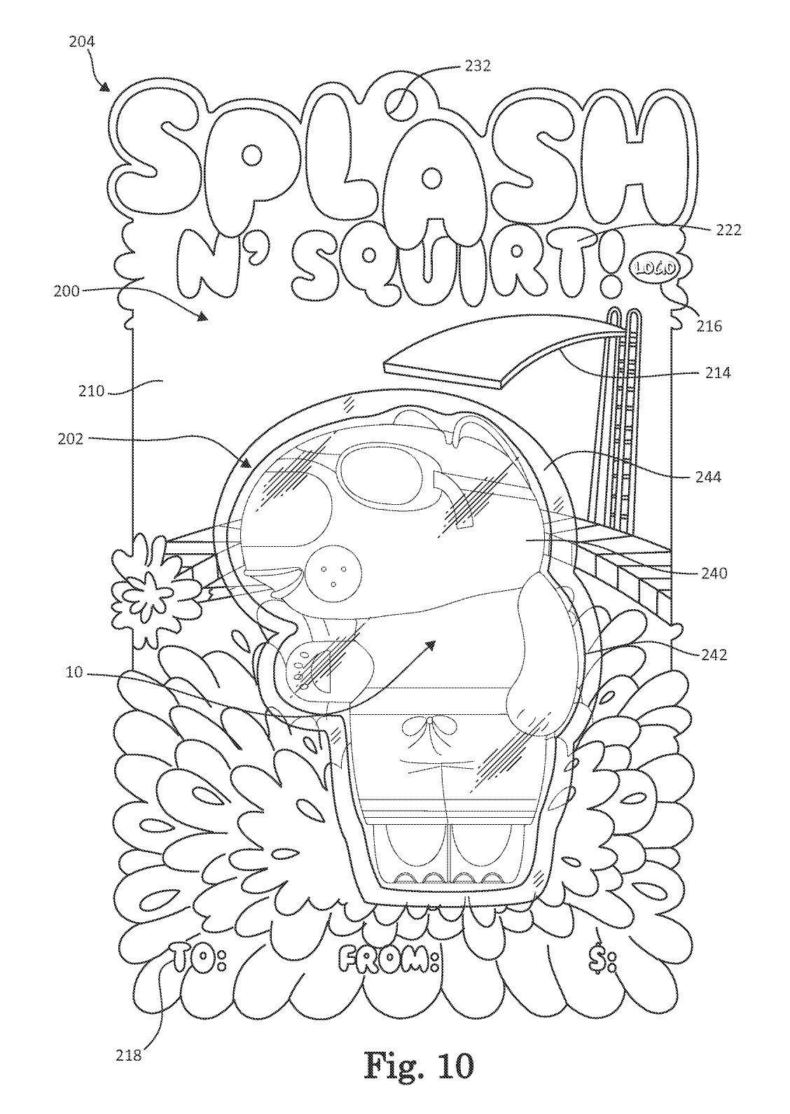

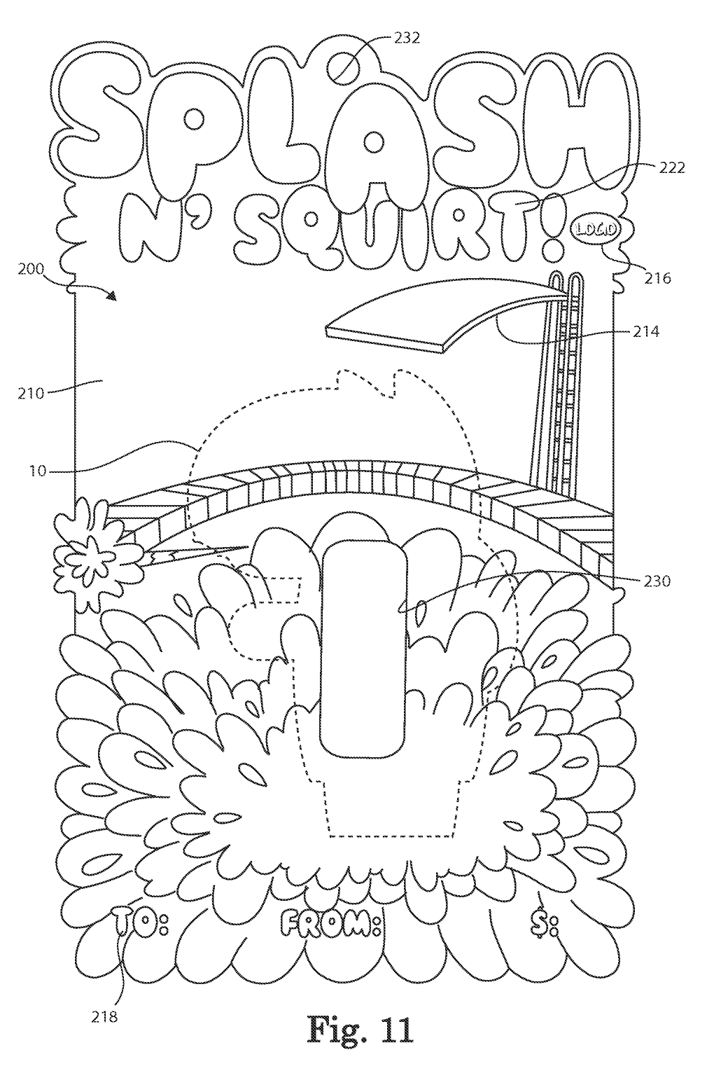

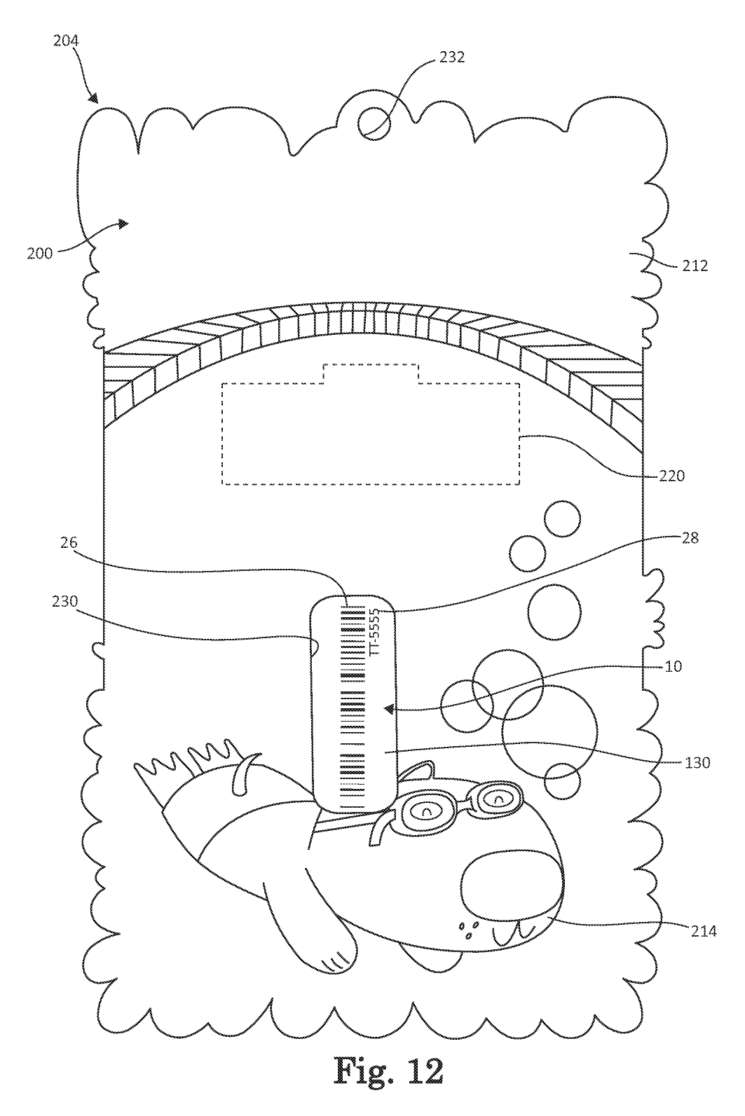

As illustrated in FIGS. 10-13, in one embodiment, transaction product 10 is supported on a carrier or backer 200 via a blister 202 to form a packaged transaction product assembly 204. Referring, for example, to the front view of FIG. 11 and the rear view of FIG. 12, backer 200 comprises a single layer or multiple layers of paper or plastic material, for example, generally in the form of a relatively stiff but bendable/flexible card. Use of other materials is also contemplated. In one embodiment, backer 200 defines a first or front surface 210 and a second or rear surface 212 positioned opposite front surface 210, where the front surface 210, as described with respect to backer 200, refers to a surface configured to face potential consumers when positioned in a retail display. In one example, one or both of front surface 210 and rear surface 212 are substantially planar. Backer 200 displays indicia, graphics or text information including store logo(s), store name(s), slogans, advertising, instructions, directions, brand indicia, promotional information, holiday indicia, seasonal indicia, media format identifiers, characters and/or other information.

For example, in one embodiment, backer 200 includes decorative indicia 214, which makes backer 200 more aesthetically pleasing to potential consumers, and also ties the visual aesthetic of backer 200 to the appearance of transaction product 10, e.g., to decorative indicia 84 on front housing member 50 and rear housing member 52. For instance, decorative indicia 214 provide background scenery or other related graphics to a common theme of transaction product 10. In the illustrated embodiment, where decorative indicia 84 depict transaction product 10 as a dog or other character, decorative indicia 214 provides an associated scene and/or includes corresponding depictions of the dog or other character.

In one embodiment, backer 200 includes brand indicia 216, which identify a store, brand, department, etc. and/or services associated with transaction product 10, and, in one example are similar to brand indicia 86. In one example, backer 200 includes indicia 218 including “to,” “from,” and “amount” fields. The fields of indicia 218 provide areas of backer 200 configured to be written upon by a consumer to personalize backer 200 for presentation as a gift to a particular recipient, for a particular purpose, and/or to indicate a value of transaction product 10.

In one embodiment, backer 200 includes redemption indicia 220, generally indicated by a dashed box in FIG. 12, indicating that transaction product 10 is redeemable for the purchase of goods and/or services and that upon use, a value of the purchased goods and/or services will be deducted from the financial account or record linked to transaction product 10. In one embodiment, redemption indicia 220 include phrases such as “<NAME OF STORE> GiftCard” and “This GiftCard is redeemable for merchandise or services at any of our stores or at our web site,” and/or provides help or phone line information in case of a lost, stolen, or damaged transaction product, etc.

As illustrated in FIG. 10, in one example, promotional indicia 222 advertise the non-transactional or amusing functionality of transaction product 10. In one embodiment, promotional indicia 222 generally indicate to a bearer of packaged transaction product assembly 204 that transaction product 10 can be used as squirt gun in addition to its financial functionality. As such, promotional indicia 222 further promote the sale of transaction product 10 by drawing the attention of a potential consumer to the non-transactional and amusing feature(s), i.e., squirt gun functionality, of packaged transaction product 10.

Any of indicia 84, 86, 214, 216, 218, 220, and 222 and/or other indicia optionally may appear anywhere on backer 200 or transaction product 10. Additional information besides that specifically described and illustrated herein may also be included and/or one or more of indicia 84, 86, 214, 216, 218, 220, and 222 may be eliminated.

In one embodiment, backer 200 includes a window or opening 230 for displaying account identifier 26 of transaction product 10 therethrough as illustrated in FIG. 12. As previously described, account identifier 26 is adapted for accessing an account or a record associated with transaction product 10 for activating, loading value to or debiting value from the account or record. In one example, transaction product 10 is coupled with or positioned adjacent front surface 210 (FIGS. 10 and 11) of backer 200, and a bearer viewing rear surface 212 (FIG. 12) of backer 200, which is opposite front surface 210, can view or access account identifier 26 through opening 230. Accordingly, opening 230 allows viewing or other access to account identifier 26 to activate and/or load transaction product 10 without removing transaction product 10 from backer 200. In one embodiment (not shown), a portion of backer 200 alternatively is configured to be folded away from the remainder of backer 200 to access account identifier 26 without removing transaction product 10 from backer 200. Other foldable or non-foldable backers can be used having various sizes and shapes for supporting transaction product 10.

In one embodiment, backer 200 defines an aperture 232 or hook configured to receive a support rod or similar structure in a retail display such that backer 200, and therefore, packaged transaction product assembly 204 as a whole, can be hung therefrom. Other suitable features for backer 200 will be apparent to those of skill in the art upon reading the present application.

Blister 202 is vacuum formed or otherwise molded from transparent and/or translucent plastic (e.g., polyvinyl chloride) or other suitable material to form a shell 240 with a cavity 182 formed therein and sized and shaped to specifically receive transaction product 10. In one example, a perimeter flange 244 extends around cavity 182. Perimeter flange 184 defines a substantially planar rear surface (not shown) of blister 202 configured to be adhered or otherwise coupled to front surface 210 of backer 200.

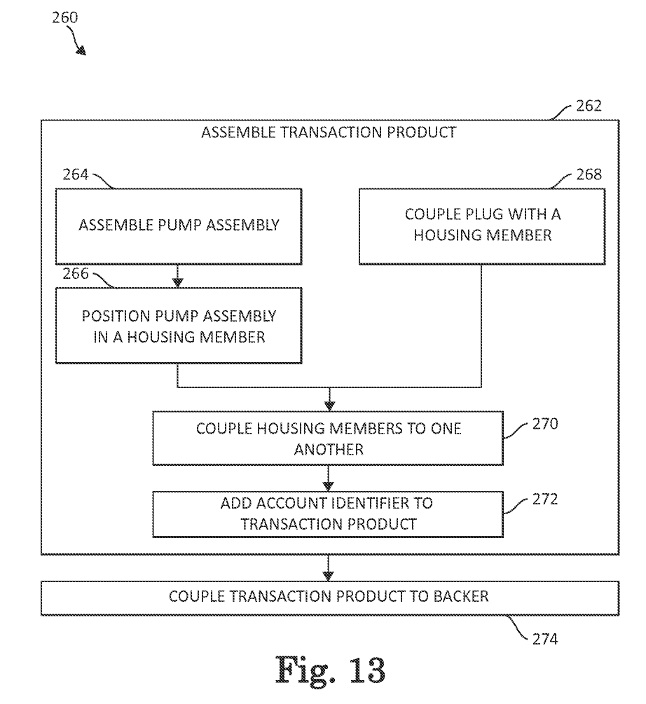

FIG. 13 is a flow chart illustrating one embodiment of a method 260 of assembling transaction product assembly 204. For example, at 262, transaction product 10 is assembled. At 264, pump assembly 14 is assembled including coupling intake tube 30 and outflow tube 34 to pump 32. Nozzle 36 is coupled to outflow tube 34 opposite pump 32. In one embodiment, trigger 16 is placed over a portion of piston 42 placing an end of piston 42 opposite cylinder 40 of pump 32 within cavity 46 of trigger 16.

Once pump assembly 14 is assembled, then, at 266, pump assembly 14 is positioned in one of front housing member 50 and rear housing member 52. For example, in the illustrated embodiment, pump assembly 14 is positioned in front housing member 50 as shown in FIG. 9, by placing nozzle 36 across nozzle housing walls 102 such that nozzle 36 directs fluid flow out of aperture 24 (i.e., an exit opening) in housing 12. Pump 32 is positioned relative to front housing member 50, for example, placing portions of pump 32 between various pump assembly registration walls 112. In one embodiment, piston 42 is seated on and between trigger housing walls 106 and over cutout 108 therein. Trigger 16 is positioned to fit snuggly against trigger cutout 94 such that flange 48 is positioned within housing 12 and a majority of casing 44 extends out of housing 12.

At 268, which may occur before, after, or substantially simultaneously with operations 264 and 266, plug 180 is coupled with housing 12, for example, with rear housing member 52. More specifically, in one embodiment, cross bar 190 is positioned adjacent inside surface 132 of rear housing member 52 such that tether 188 extends through filing hole 146, positioning cork 182 external to rear housing member 52 and housing 12 as a whole. In one embodiment, cork 182 is placed within filling hole 146.

At 270, front housing member 50 and rear housing member 52 are coupled to one another placing chamber 64 of front housing member 50 in communication with chamber 124 of rear housing member 52 to collectively define reservoir 54 and enclose pump assembly 14 and a portion of trigger 16. More specifically, front housing member 50 is placed on rear housing member 52 or vice versa. In one example, front housing member 50 is placed on rear housing member 52 such that inside edge 90, nozzle housing walls 102, and trigger housing walls 106 of front housing member 50 align and directly abut inside edge 140, nozzle housing walls 162, and trigger housing walls 166, respectively. Abutting portions of front housing member 50 and rear housing member 52 are adhered, ultrasonically welded, and/or are otherwise secured to one another in a liquid-tight (e.g., watertight) manner such that reservoir 54 is configured to maintain water 18 without substantial leaking from housing 12. Other methods of securing front housing member 50 to rear housing member 52 to one another are also contemplated.

At 272, account identifier 26 is added to housing 12. In one example, once housing 12 is assembled, housing 12 forms outside surface 70 of front portion 60 with three-dimensional features defining a character, etc. while forming outside surface 130 of rear portion 120 to be substantially planar to receive account identifier 26. In one embodiment, account identifier 26 is printed to outside surface 130 of rear housing member 52, which is a substantially planar surface as described above. In one example, a magnetic strip RFID tag or other form of account identifier 26 is adhered or otherwise coupled to outside surface 130. Although pictured in FIG. 13 and described above as occurring after operations 264, 266, 268, and 270, it should be understood that account identifier 26 may be applied to housing 12 or any portion thereof at any suitable time during manufacturing and assembly. For example, account identifier 26 may be molded into or otherwise integrally formed as part of housing 12, may be enclosed within housing 12, and/or may be printed or otherwise applied to housing 12 before or after one or more of operations 264, 266, 268, and 270 as will be apparent to those of skill in the art upon reading this application.

At 274, transaction product 10 is coupled with backer 200, as generally illustrated with additional reference to FIGS. 10 and 11, to form transaction product assembly 204 to package transaction product 10 for retail sale. Transaction product 10 may be adhered, skinned to, clam packed to, blister packed with or otherwise suitably coupled with backer 200. For example, transaction product 10 is placed in cavity 242 of blister 202, and a rear surface (not shown) of perimeter flange 244 is placed adjacent to and coupled to front surface 210 of backer 202, for example, via a heat seal adhesive or other suitable method. In one example, blister 202, maintaining transaction product 10, is secured to backer 200 in a manner aligning account identifier 26 of transaction product 10 with opening 230 in backer 200 such that account identifier 26 is accessible for scanning while transaction product 10 is coupled with backer 200. Once transaction product 10 is assembled and packaged during method 260, transaction product assembly 204 is ready for retail display, etc.

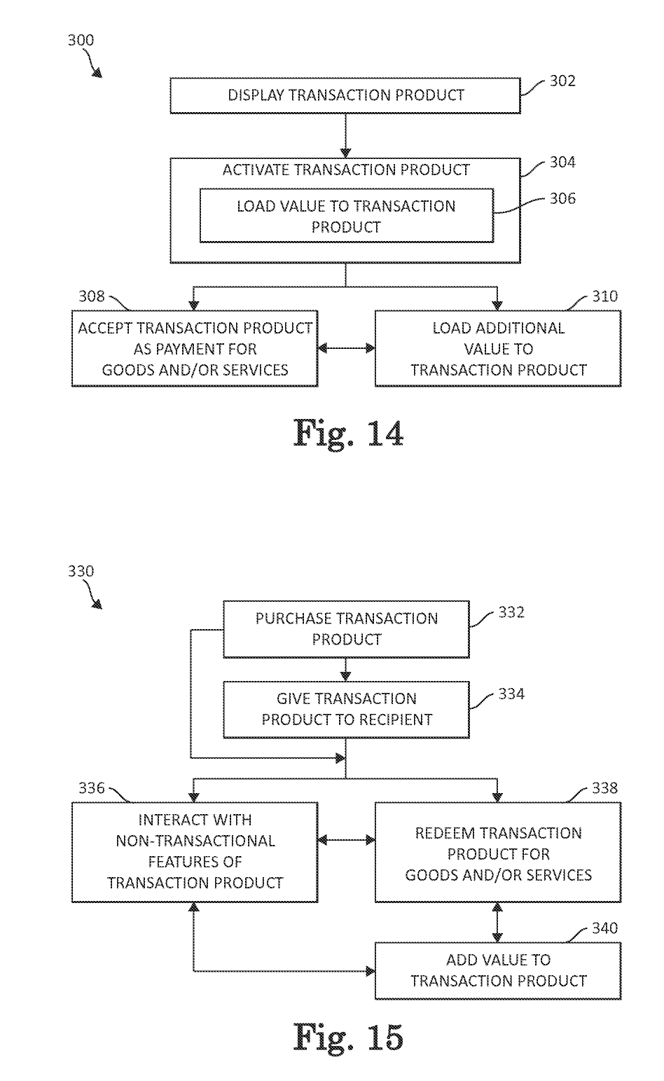

FIG. 14 is a flow chart illustrating one embodiment of a method 300 of encouraging purchase and facilitating use of transaction product assembly 204 by consumers and/or recipients. At 302, transaction product assembly 204 is placed on or hung from a rack, shelf, or other similar device to display transaction product assembly 204, and therefore, transaction product 10, for sale to potential consumers. In one embodiment, a depiction of transaction product 10 and/or transaction product assembly 204 is additionally or alternatively placed on a website for viewing and purchase by potential consumers.

At 304, a consumer who has decided to purchase transaction product assembly 204 presents transaction product assembly 204 to a retail store employee, retail store kiosk, remote terminal, or other person or device to scan account identifier 26 using a point-of-sale terminal or other machine to access an account or record linked to account identifier 26. Notably, as used herein “purchase” of transaction product assembly 204 does not require a fee or other dollar amount to be paid for transaction product 10, but rather that transaction product 10 is being activated and funds placed in the associated account or record. In one example, purchase of transaction product assembly 204 does require a fee to be paid to the retail store or setting. In particular, account identifier 26 is scanned or otherwise accessed, for example through opening 230 of backer 200 to activate transaction product assembly 204, more particularly, transaction product 10 and the remote, database stored account or record linked thereto. Upon accessing the account or record, then, at 306, value is added to the account or record in the form of monetary value, points, minutes, etc. Thus, transaction product 10 is activated and loaded for future use toward a purchase or use of goods and/or services.

In one example, a predetermined value is associated with transaction product 10 (i.e., associated with the account or record linked to transaction product 10 via account identifier 26) prior to activation and display, but such predetermined value is not initially available for use toward the purchase or use of goods and/or services. In such an embodiment, at 304, transaction product 10 is activated to permit subsequent access to the predetermined value (e.g., subsequent loading on and debiting from the account or record) and no additional value is added during activation such that operation 306 may be eliminated.

Once transaction product 10 is activated and loaded, transaction product 10 can be used by the consumer or any other bearer of transaction product 10 to purchase goods and/or services at the affiliated retail setting (e.g., a retail store or website) or can be used in exchange for calling minutes, etc. In one embodiment, where transaction product 10 is displayed on a website at 302, then, at 304, transaction product 10 may be activated in any suitable method and may not require the physical scanning of account identifier 26 to be activated or to otherwise access the associated account or record such as at 306.

In one example, at 308, the retail store or other affiliated retail setting or website accepts transaction product 10, or more precisely, value in the account or record linked to transaction product 10 via account identifier 26, as payment toward the purchase of goods and/or services made by the current bearer of transaction product 10. In particular, the value currently loaded on transaction product 10 (i.e., stored or recorded in the account or record linked to account identifier 26) is applied toward the purchase of goods and/or services. At 310, additional value is optionally loaded on transaction product 10 at a point-of-sale terminal, kiosk or other area of the retail store or related setting using account identifier 26. Upon accepting transaction product 10 as payment at 308, the retail store or related setting can subsequently perform either operation 308 or operation 310 as requested by a current bearer of transaction product 10. Similarly, upon loading additional value on transaction product 10 at 310, the retail store or related setting can subsequently perform either operation 310 again or operation 308. In one example, the ability to accept transaction product 10 as payment for goods and/or services is limited by whether the account or record associated with transaction product 10 has any value stored or recorded therein at the time of attempted redemption.

FIG. 15 is a flow chart illustrating one embodiment of a method 330 of using transaction product assembly 204. At 332, a potential consumer of transaction product assembly 204, which is displayed in a retail store or viewed on a website, decides to and does purchase transaction product assembly 204 from the retail store or website. Upon purchasing transaction product assembly 204, a retail store employee, a retail store kiosk or other person or device scans account identifier 26 (FIGS. 3 and 12) through opening 230 of backer 200 or otherwise reads or accesses account identifier 26. Upon accessing account identifier 26, the account or record linked to account identifier 26 is accessed and activated to load value onto transaction product 10 (i.e., load value to the account or record associated with transaction product 10). In one embodiment, such as where transaction product assembly 204 is purchased at 332 via a website, actual scanning or other mechanical detection of account identifier 26 may be eliminated.

At 334, the consumer optionally gives transaction product assembly 204 to a recipient, such as a graduate, relative, friend, expectant parents, one having a recent or impending birthday, a couple having a recent or impending anniversary, etc. In one embodiment, a plurality of transaction product assembly 204 are purchased and given to partygoers, such as at a birthday party, etc. as party favors or gifts. As an alternative, the consumer can keep transaction product assembly 204 for his or her own use thereby eliminating operation 334.

At 336, the consumer, recipient, or other current bearer of transaction product assembly 204 interacts with the non-transactional features thereof for amusement. More specifically, the bearer of transaction product assembly 204 removes transaction product 10 from packaging (e.g., backer 200 and blister 202), fills reservoir 54 with water 18 of other suitable fluid via filling hole 146 and expels portions of water 18 via nozzle 36 by pulling or otherwise interacting with trigger 16 as described above. Such use amuses the bearer and any other observers of transaction product 10.

At 338, the consumer or recipient redeems transaction product 10 for goods and/or services from the retail store or website. At 340, the consumer or recipient of transaction product 10 optionally adds value to transaction product 10, more particularly, to the account or record associated with account identifier 26 included therewith, at the retail store or over the Internet (i.e., via the website). Upon interacting with the non-transaction feature of transaction product 10 at 336, redeeming transaction product 10 at 338 or adding value to transaction product 10 at 340, the consumer or recipient of transaction product assembly 204 subsequently can perform any of operations 336, 338, or 340 as desired. In one embodiment, the ability of the consumer or recipient to repeat redeeming transaction product 10 at 338 is limited by whether the account or record linked with transaction product 10 has any remaining value stored or recorded therein at the time of attempted redemption.

Although described above as occurring at a single retail store or website, in one embodiment, purchasing transaction product assembly 204 at 332, redeeming transaction product 10 at 338, and adding value to transaction product 10 at 340, can each be performed at any one of a number of stores adapted to accept transaction product 10 or over the Internet. In one example, a number of stores are each part of a chain or are similarly branded stores. In one example, a number of stores include at least one website and/or at least one conventional brick and mortar store.

Transaction cards and other products come in many forms, according to embodiments of the invention. Stored-value cards, like other transaction cards, can be “re-charged” or “re-loaded” at the direction of the original consumer, the gift recipient or a third party. The term “loading on” or “loaded on” herein should be interpreted to include adding to the balance of an account or record associated with a transaction card. The balance associated with the transaction card declines as the card is used, encouraging repeat visits or use. The card remains in the user's purse or wallet, serving as an advertisement or a reminder to revisit the associated merchant. Stored-value cards according to embodiments of the invention provide a number of advantages to both the consumer and the merchant. Other stored-value cards and transaction cards according to embodiments of the invention include loyalty cards, merchandise return cards, electronic gift certificates, calling cards, employee cards, frequency cards, prepaid cards and other types of cards associated with or representing purchasing power, monetary value, etc.

Although the invention has been described with respect to particular embodiments, such embodiments are meant for illustrative purposes only and should not be considered to limit the invention. Various alternatives and changes will be apparent to those of ordinary skill in the art. Other modifications within the scope of the invention and its various embodiments will be apparent to those of ordinary skill.

What is claimed is:

1. A transaction product comprising:
a substantially rigid housing defining a substantially liquid-tight reservoir, an outflow aperture, and an external surface, wherein the substantially liquid-tight reservoir is configured to maintain a liquid therein;
a pump assembly enclosed within the substantially rigid housing and in communication with the substantially liquid-tight reservoir and the outflow aperture, wherein the pump assembly is configured to move liquid from the substantially liquid-tight reservoir, through the pump assembly, out the outflow aperture, and into an external environment surrounding the substantially rigid housing; and
an account identifier statically connected to the external surface of the substantially rigid housing, wherein the account identifier links the substantially rigid housing to at least one of an account and a record and is machine readable by a point-of-sale terminal.

2. The transaction product of claim 1, wherein the account identifier is a bar code.

3. The transaction product of claim 1, wherein the account identifier includes at least one of a bar code, a magnetic strip, a smart chip, and a radio frequency identification (RFID) device.

4. The transaction product of claim 1, in combination with a database storing the at least one of the account and the record, wherein the database tracks a monetary value associated with the at least one of the account and the record, and the monetary value is available for use toward a price of a future purchase.

5. The transaction product of claim 1, wherein:
the pump assembly includes:
an intake tube in communication with the substantially liquid-tight reservoir,
a pump, and
an outflow tube in communication with the outflow aperture, and
the pump assembly is configured to move liquid from the substantially liquid-tight reservoir through the intake tube, the pump, and the outflow tube of the pump assembly and to expel the liquid out of the substantially rigid housing via the outflow aperture.

6. The transaction product of claim 1, wherein:
the pump assembly includes a piston for actuating the pump assembly to move liquid from the substantially liquid-tight reservoir, through the pump assembly, and out the outflow aperture of the housing,
the transaction product further comprises a trigger coupled to the piston,
the trigger extends from within the substantially rigid housing to outside the substantially rigid housing and is movable from a first position to a second position to actuate the pump assembly to expel liquid from the housing, and
the trigger extends farther away from the substantially rigid housing in the first position than in the second position and is biased toward the first position.

7. The transaction product of claim 6, wherein:
the housing include three-dimensional features defining a character, and
the trigger defines an appendage of the character.

8. The transaction product of claim 1, wherein:
the substantially rigid housing defines a filling hole; and
the transaction product includes a plug sized and shaped to fit within the filling hole to selectively close the filling hole in a substantially liquid-tight manner.

9. The transaction product of claim 1, wherein the substantially rigid housing is formed in a substantially L-shaped configuration including a handle portion and a barrel portion extending substantially perpendicular relative to one another.

10. The transaction product of claim 9, wherein:
the pump assembly includes a piston for actuating the pump assembly to move liquid from the substantially liquid-tight reservoir,
the transaction product further comprises a trigger coupled to the piston, the trigger extends partially within and partially outside the substantially rigid housing,
the trigger is movable from a first position to a second position, which moves the piston to actuate the pump assembly to move liquid from the substantially liquid-tight reservoir,
the trigger extends farther away from the substantially rigid housing in the first position than in the second position and is biased toward the first position, and
the trigger extends from the handle portion just below the barrel portion of the transaction product such that, when a bearer of the transaction product grips the handle portion with one hand, the bearer can interact with the trigger using the one hand while the one hand remains gripped around the handle portion.

11. The transaction product of claim 10, wherein:
the barrel portion defines a head of a character,
the handle portion defines a body of the character, and
the trigger defines an appendage of the character.

12. The transaction product of claim 1, wherein:
the substantially rigid housing includes an external surface having a front portion and a rear portion,
the front portion exhibits three-dimensional features, and
the rear portion is substantially planar and supports the account identifier.

13. The transaction product of claim 1, in combination with a backer coupled to and supporting the transaction product, wherein the backer includes an aperture providing access to the account identifier of the transaction product through the backer while the transaction product is coupled to the backer.

14. A stored-value item, comprising:
means for holding water and defining a first external surface facing away from the water;
means for moving and expelling the water from the means for holding water; and
means for linking the means for holding water with an account or record maintaining a monetary balance available for use toward a price of one or both of a future purchase and a future use of one or more of a product and a service, wherein the means for linking is coupled to the first external surface of the means for holding.

15. The stored-value item of claim 14, wherein the means for holding water defines means for filling and refilling the means for holding water with the water.

16. The stored-value item of claim 14, wherein:
the means for holding water defines:
a second external surface opposite the first external surface, and
means for defining a character including means for providing areas of relief to the first external surface of the means for holding water, and
the means for linking is secured to the second external surface of the means for holding water.

17. The stored-value item of claim 14, further comprising means for actuating the means for moving and expelling water to move and expel the water from the means for holding water upon user interaction with the means for actuating.

18. A method of providing and facilitating use of a stored-value product, the method comprising:
providing the stored-value product, the stored-value product comprising:
an enclosure defining an internal chamber for selectively maintaining water therein and an exit opening,
a water movement assembly substantially maintained within the enclosure in communication with the internal chamber and the exit opening, the water movement assembly being configured to move water from the internal chamber through the water movement assembly and to push water from the water movement assembly expelling the water out the exit opening of the enclosure, and
an account identifier secured to the enclosure and linking the stored-value product to a financial account having a monetary balance; and
using a point-of-sale terminal to read the account identifier and activate the financial account linked to the stored-value product via the account identifier such that the monetary balance of the financial account is available for use toward a purchase price when the stored-value product is offered as tender toward the purchase price.

19. The method of claim 18, further comprising:
using another point-of-sale terminal to accept the stored-value product as tender toward the purchase price including using the another point-of-sale terminal to read the account identifier from the stored-value product and access the financial account based on the account identifier read from the stored-value product.

20. The method of claim 18, further comprising displaying the stored-value product to potential consumers prior to using the point of sale terminal to read the account identifier and activate the financial account linked to the stored-value product, the displaying including promoting the stored-value product as being a squirt gun in addition to being useful as tender toward the purchase price.

21. The method of claim 20, wherein:
displaying the stored-value product includes displaying the stored-value product on a support backer hung from a display fixture, the backer being configured to provide access to the account identifier while the stored-value product is secured to the backer.

22. The method of claim 20, wherein:
providing the stored-value product includes providing the stored-value product with a trigger extending partially within and partially out of the enclosure, and
the trigger is biased toward a first position and moveable from the first position to a second position to, when water is maintained in the water movement assembly, cause the water movement assembly to move water from the internal chamber through the water movement assembly and to push water from the water movement assembly expelling the water out the exit opening of the enclosure.

23. The method of claim 20, wherein providing the stored-value product is performed such that:
the enclosure defines a barrel portion and a handle portion extending downwardly from and substantially perpendicular relative to the barrel portion,
the enclosure defines a character such that the size and shape of the handle portion represents a body of the character and the size and shape of the barrel portion represents a head of the character,
the barrel portion depicts a mouth on the head of the character, and
the exit opening is positioned to align with the mouth.

24. The method of claim 21, wherein:
the enclosure defines a front external surface, and
providing the stored-value product includes further defining the character in a three-dimensional manner with non-planar features on the front external surface of the enclosure.

25. The method of claim 24, wherein:
the enclosure defines a rear external surface, which is opposite the front external surface of the enclosure, and a side extending between the front external surface and the rear external surface,
providing the stored-value product includes providing the account identifier statically secured to the rear external surface of the enclosure, and
the exit opening is defined through the side of the enclosure.
